(19) United States
(12) Patent Application Publication
(10) Pub. No.: US 2026/0295969 A1
(43) Pub. Date: Oct. 1, 2026

(54) MULTILAYER BODY

(71) Applicant: TOYO QUALITY ONE CORPORATION, Kawagoe-city, Saitama (JP)

(72) Inventors: Shinya YAMAGUCHI, Kawagoe-city (JP); Ryuji MINOWA, Kawagoe-city (JP)

(73) Assignee: TOYO QUALITY ONE CORPORATION, Kawagoe-city, Saitama (JP)

(21) Appl. No.: 19/479,564

(22) PCT Filed: Feb. 12, 2024
(86) PCT No.: PCT/JP2024/004700

§ 371 Date: Oct. 28, 2025

(30) Foreign Application Priority Data
Apr. 28, 2023 (JP) 2023-073895
Dec. 4, 2023 (JP) 2023-204307

(51) Int. Cl. B32B 5/24; B32B 3/30; B32B 5/18; B32B 37/04

(52) U.S. Cl. CPC B32B 5/245; B32B 3/30; B32B 5/18; B32B 37/04; B32B 2266/0278; B32B 2266/06; B32B 2307/724; B32B 2307/7376

(57) ABSTRACT

A multilayer body includes: a soft polyurethane foam; and a base fabric pasted on the soft polyurethane foam. The base fabric is fixed to the soft polyurethane foam by fusing the soft polyurethane foam. The soft polyurethane foam has an air permeability of 160 mL/cm²/s or more and 450 mL/cm²/s or less. The multilayer body may further include a skin pasted on a surface of the soft polyurethane foam, the surface being opposite to a surface thereof to which the base fabric has been fixed. The skin is fixed to the soft polyurethane foam by fusing the soft polyurethane foam.

### TECHNICAL FIELD

The present invention relates to a multilayer body in which a soft polyurethane foam is used.

### BACKGROUND ART

Patent Document 1 discloses a conventional technology related to a multilayer body in which a base fabric has been adhered to a soft polyurethane foam.

### PRIOR ART DOCUMENT

### Patent Document

Patent Document 1: Japanese Patent Application Laid-Open (kokai) No. 2021-53970

### SUMMARY OF THE INVENTION

### Problem to be Solved by the Invention

In the conventional technology, the base fabric is pasted on the soft polyurethane foam by a hot-melt adhesive. Thus, the elasticity and the stretchability of the soft polyurethane foam in the multilayer body might be impaired by an adhesion layer obtained by curing the hot-melt adhesive.

The present invention is made to solve the above problem, and an object of the present invention is to provide a multilayer body in which losses in the elasticity and the stretchability of a soft polyurethane foam can be decreased.

### Means for Solving the Problem

A first aspect for achieving the object is directed to a multilayer body including: a soft polyurethane foam; and a base fabric pasted on the soft polyurethane foam, wherein the base fabric is fixed to the soft polyurethane foam by fusing the soft polyurethane foam, and the soft polyurethane foam has an air permeability of 160 mL/cm²/s or more and 450 mL/cm²/s or less.

A second aspect is directed to the multilayer body according to the first aspect, further including a skin pasted on a surface of the soft polyurethane foam, the surface being opposite to a surface thereof to which the base fabric has been fixed, wherein the skin is fixed to the soft polyurethane foam by fusing the soft polyurethane foam.

A third aspect is directed to the multilayer body according to the second aspect, wherein an air permeability of the multilayer body with respect to an air permeability of the skin is 74% or higher.

A fourth aspect is directed to the multilayer body according to any one of the first to third aspects, wherein the soft polyurethane foam includes: cells, the number of which is 20 to 40/25 mm; and air bubbles leading to the cells and having an opening proportion of 90% or higher.

A fifth aspect is directed to the multilayer body according to the fourth aspect, wherein the soft polyurethane foam further includes a rib between the air bubbles, the rib having a thickness of 80 μm or larger and 120 μm or smaller.

### Advantageous Effects of the Invention

In the present invention, the base fabric is fixed by fusing the soft polyurethane foam having an air permeability of 160 mL/cm²/s or more and 450 mL/cm²/s or less, whereby losses in the elasticity and the stretchability of the soft polyurethane foam can be decreased.

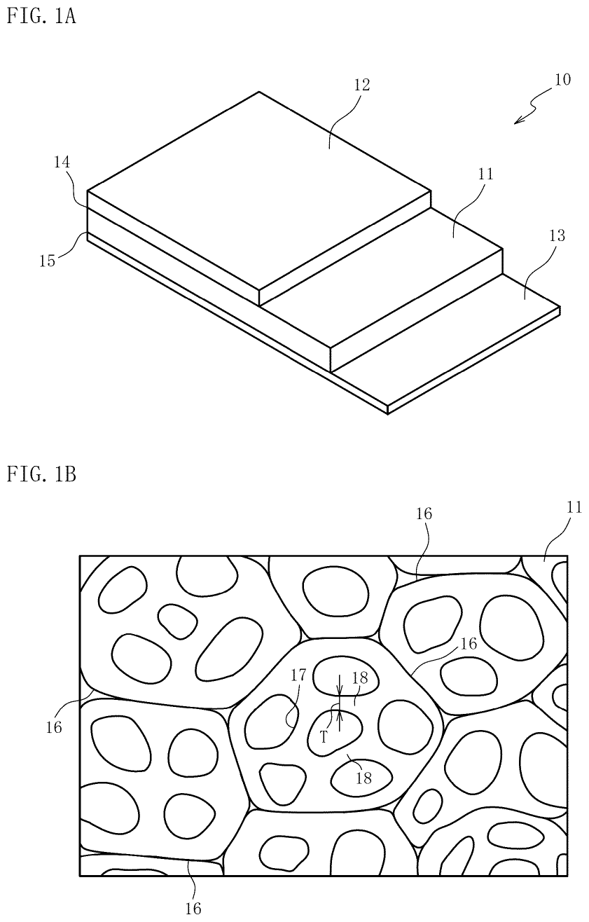

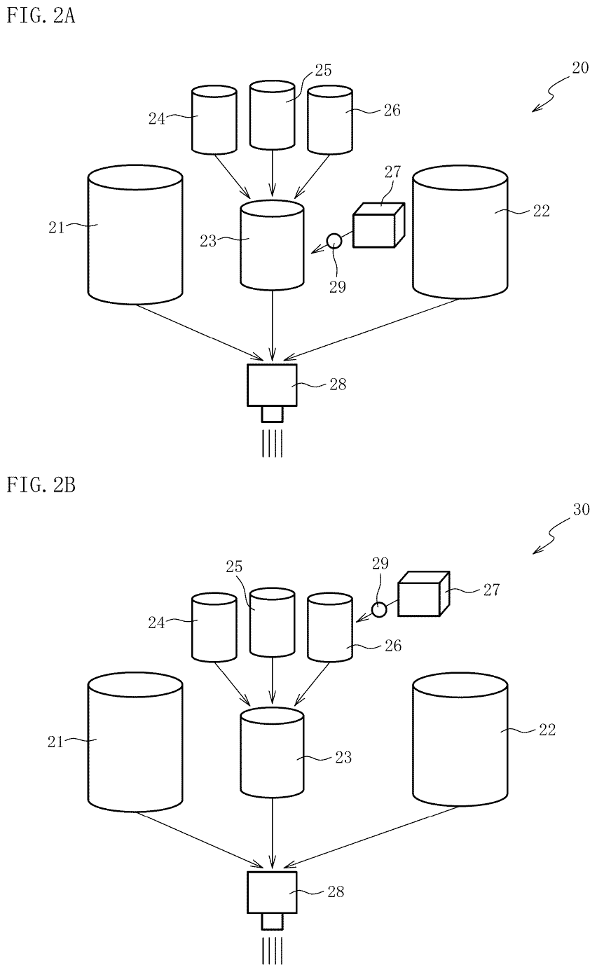

### BRIEF DESCRIPTION OF THE DRAWINGS

[FIG. 1] (a) is a perspective view of a multilayer body, and (b) is a schematic diagram of a cross section of a soft polyurethane foam.

[FIG. 2] (a) is a schematic diagram of a mixing device for raw materials of the soft polyurethane foam, and (b) is a schematic diagram of another mixing device for the raw materials of the soft polyurethane foam.

### MODES FOR CARRYING OUT THE INVENTION

Hereinafter, a preferred embodiment of the present invention will be described with reference to the drawings. FIG. 1(a) is a perspective view of a multilayer body 10. The multilayer body 10 includes: a soft polyurethane foam 11; a skin 12 fixed to the front surface of the soft polyurethane foam 11; and a base fabric 13 fixed to the back surface of the soft polyurethane foam 11. The skin 12 is fixed to the soft polyurethane foam 11 via a fusion layer 14 provided on the front surface of the soft polyurethane foam 11. The base fabric 13 is fixed to the soft polyurethane foam 11 via a fusion layer 15 provided on the back surface of the soft polyurethane foam 11. Examples of use of the multilayer body 10 include a skin material for coating a seating surface or a rear surface of a seat in a vehicle or the like. The skin material is made by shearing and sewing the multilayer body 10 into such a shape as to cover such a seat.

The skin 12 is a member for decorating the multilayer body 10 or improving the texture of the multilayer body 10. Examples of the skin 12 include leather, synthetic leather, fabric, and the like. In a case where a material having a low air permeability such as leather or synthetic leather is used for the skin 12, a plurality of holes penetrating the skin 12 are formed through punching or perforation in order to ensure air permeability of the multilayer body 10. As a matter of course, a fiber article such as nonwoven fabric may be provided between the skin 12 and the soft polyurethane foam 11.

The base fabric 13 is a member for protecting the soft polyurethane foam 11. The base fabric 13 enables a favorable slip at the time of covering a seat with the skin material or sewing the skin material. Examples of the base fabric 13 include fiber articles such as woven fabric, knitted fabric, and nonwoven fabric. Examples of materials of the fiber articles include nylons, polyesters, and the like. In order to ensure air permeability, the base fabric 13 is suitably a fiber article having a weight per unit area of 5 to 50 g/m² and is suitably a fiber article having an air permeability of 750 mL/cm²/s or more, the air permeability being measured according to the method B of JIS K 6400-7: 2012.

The soft polyurethane foam 11 is obtained by foaming a raw material composition containing a polyol, an isocyanate, a foaming agent, and an aid containing a catalyst and a foam stabilizer. Examples of the thickness of the soft polyurethane foam 11 include 2 to 20 mm.

The polyol is not particularly limited as long as the polyol is a compound having two or more hydroxyl groups, and a publicly-known polyol to be used for molding a soft polyurethane foam is selected. Examples of a component of the polyol include one or more types of hydroxyl-terminated compounds selected from the group consisting of hydroxyl-terminated compounds containing polyethers, polyesters, polycarbonates, polydienes, and polycaprolactones.

Examples of the hydroxyl-terminated compounds containing polyethers include polyether polyols each obtained by adding an alkylene oxide such as ethylene oxide or propylene oxide to a polyhydric alcohol such as ethylene glycol, diethylene glycol, propylene glycol, dipropylene glycol, butylene glycol, neopentyl glycol, glycerin, pentaerythritol, trimethylolpropane, sorbitol, or sucrose.

Examples of the hydroxyl-terminated compounds containing polyesters include polyester polyols each obtained by polycondensation of, for example, an aliphatic carboxylic acid such as malonic acid, succinic acid, or adipic acid or an aromatic carboxylic acid such as phthalic acid, and an aliphatic glycol such as ethylene glycol, diethylene glycol, or propylene glycol.

Examples of the hydroxyl-terminated compounds containing polyethers and polyesters include: polyether-ester polyols each obtained by polyesterification through a reaction between a polyether polyol and a polybasic acid; and polyether-ester polyols each having both a polyether segment and a polyester segment in one molecule thereof.

The polyol can be selected from the group consisting of hydroxyl-terminated polyhydrocarbons, hydroxyl-terminated polyformals, fatty acid triglycerides, hydroxyl-terminated polyesters, hydroxymethyl-terminated polyesters, hydroxymethyl-terminated perfluoromethylene, polyalkylene ether glycols, polyalkylene-arylene ether glycols, and polyalkylene ether triols. The component of the polyol can be selected also from the group consisting of adipic acid-ethylene glycol polyesters, poly(butylene glycols), poly(propylene glycols), and hydroxyl-terminated polybutadienes.

As a polyol to which a polypropylene glycol has been added, a polyol having a hydroxyl value of 20 to 170 mgKOH/g and a weight-average molecular weight of 1000 to 7000 and having 2 or 3 functional groups is preferable. Regarding the existence ratio between the propylene oxide (PO) and the ethylene oxide (EO), the proportion of the EO is preferably 0 to 50% and more preferably 0 to 15%.

Examples of the isocyanate include: aliphatic, alicyclic, and aromatic polyisocyanates having two or more isocyanate groups; mixtures thereof; and modified polyisocyanates obtained by modifying these isocyanates. Examples of the aliphatic polyisocyanates include hexamethylene diisocyanate, isophorone diisocyanate, and dicyclohexamethane diisocyanate. Examples of the aromatic polyisocyanates include toluene diisocyanate (TDI), diphenylmethane diisocyanate (MDI), naphthalene diisocyanate, xylylene diisocyanate, and polymeric MDI (crude MDI).

Examples of the foaming agent include water, carbon dioxide, and low-boiling-point organic compounds. Examples of the low-boiling-point organic compounds include: hydrocarbons such as methane, ethane, propane, butane, pentane, and hexane; and halogenated hydrocarbons such as halogenated methanes, halogenated ethanes, and fluorinated hydrocarbons. Examples of the halogenated hydrocarbons include methylene chloride, HCFC-141b, HFC-245fa, and HFC-356mfc.

As the foaming agent, water, carbon dioxide, and the low-boiling-point organic compounds may be used singly or may be used in combination. The foaming agent preferably contains water as a main component. The reason for this is because such a foaming agent is easily handled. The phrase “contains water as a main component” means that the proportion of the water in the foaming agent exceeds 50% by mass. The blending amount of the foaming agent per 100 parts by weight of the polyol is preferably 2 to 5 parts by weight. The purpose for this is to ensure moldability and elasticity of the soft polyurethane foam. However, the blending amount of the foaming agent may be outside this range if the moldability and the elasticity of the soft polyurethane foam can be ensured by adjusting a specific gravity or the like.

The aid contains a catalyst and a foam stabilizer. Examples of the catalyst include amine-based catalysts and metal catalysts. Examples of the amine-based catalysts include triethylamine, triethylenediamine, diethanolamine, dimethylaminomorpholine, N-ethylmorpholine, N,N-dimethylaminoethanol, N,N-dimethyl-4-morpholineethanamine, and tetramethylguanidine. Examples of the metal catalysts include tin catalysts such as tin (II) octylate and dibutyltin dilaurate, potassium acetate, potassium octylate, and lead octylate. These catalysts may be used singly, or two or more types of these catalysts may be used in combination.

The foam stabilizer is a component for promoting and stabilizing formation of air bubbles in the soft polyurethane foam. Examples of the foam stabilizer include: organic silicon-based surfactants; and anionic surfactants such as fatty acid salts, sulfuric acid ester salts, phosphoric acid ester salts, and sulfonic acid salts.

The aid may further contain a foam breaker, a flame retardant, or an antioxidant. Examples of the foam breaker include: hydrocarbon-based foam breakers such as polybutene; ester-based foam breakers such as dimer acid diesters; and silicone-based foam breakers such as cyclopentasiloxane. Examples of the flame retardant include phosphoric-acid-ester-based flame retardants and halogenated phosphoric acid esters. Examples of the antioxidant include triazole-based antioxidants and benzophenone-based antioxidants. The raw material composition may contain a colorant. Examples of the colorant include pigments and dyes.

FIG. 2(a) is a schematic diagram of a mixing device 20 for the raw materials of the soft polyurethane foam 11. The mixing device 20 includes: a first container 21 containing the polyol; a second container 22 containing the isocyanate; and a third container 23 containing the aid. To the third container 23, a fourth container 24 containing the foaming agent, a fifth container 25 containing the catalyst, and a sixth container 26 containing the foam stabilizer are connected. A gas in a gas container 27 is mixed with the aid in the third container 23 through a flowmeter 29, and gas-liquid mixing therebetween is performed through agitation with an agitator such as an Oakes mixer or a Hobart mixer.

The gas to be mixed with the aid is not particularly limited and only has to be a gas that is inert with respect to the polyol and the isocyanate. Examples of the gas include: inert gases such as nitrogen gas and argon gas; and dry air. The gas may be mixed with the aid through agitation while a gas present around the aid is being taken in.

The soft polyurethane foam 11 is obtained by: agitation-mixing, by a mixer 28, a raw material composition containing the aid with which the gas has been mixed, the polyol, the isocyanate, and the foaming agent; then supplying the raw material composition onto paper or a film continuously sent out together with a conveyor (not shown); causing a resin formation reaction between the polyol and the isocyanate and a foaming reaction between the isocyanate and the foaming agent to simultaneously progress to cure the raw material composition; and then slicing core portions exposed by removing skin layers on the outer surface. Air bubbles due to the gas mixed with the aid are formed in addition to air bubbles due to the foaming agent, and a homogeneous cell structure is formed in the soft polyurethane foam 11.

A mechanical froth method is known in which: a gas such as inert gas is agitation-mixed with the entirety of a raw material composition containing an aid containing a catalyst and a foam stabilizer, a polyol, an isocyanate, and a foaming agent; and the resultant raw material composition is used to mold a soft polyurethane foam. A method according to the present embodiment differs from the mechanical froth method in that the gas is agitation-mixed with the aid containing the catalyst and the foam stabilizer, and then the polyol, the isocyanate, and the like are mixed.

In the method according to the present embodiment, the gas is agitation-mixed with the aid, the amount of which is smaller than the amount of the entirety of the raw material composition, whereby the gas can be evenly mixed with the aid. Since the gas is mixed with the aid containing the catalyst for promoting a resin formation reaction or the like and the foam stabilizer for increasing compatibility among the raw materials as components and decreasing the surface tensions of the raw materials, the gas contained in the aid is evenly dispersed in the soft polyurethane foam 11, and the cell structure thereof is stabilized. Therefore, a soft polyurethane foam 11 having a high air permeability is obtained. In order to ensure the high air permeability of the soft polyurethane foam 11, an amount of the gas to be mixed with the aid per 100 parts by weight of the polyol is preferably 10×10⁻³ m³ or larger and 200×10⁻³ m³ or smaller, the amount being equivalent to an amount in a standard state at 0° C. and at 1 atm.

Instead of utilizing the foaming reaction between the isocyanate and the foaming agent, a low-boiling-point substance that vaporizes owing to heat at the time of foam molding may be utilized as a foaming agent. Instead of molding the soft polyurethane foam 11 on a conveyor, the soft polyurethane foam 11 may be molded through batch foaming with pressure being released.

FIG. 2(b) is a schematic diagram of another mixing device 30 for the raw materials of the soft polyurethane foam 11. Portions identical to those of the mixing device 20 shown in FIG. 2(a) will be denoted by the same reference characters and will not be described below.

In the mixing device 30, the gas in the gas container 27 is mixed with the foam stabilizer in the sixth container 26 through the flowmeter 29, and gas-liquid mixing therebetween is performed through agitation with an agitator such as an Oakes mixer or a Hobart mixer. This foam stabilizer with which the gas has been agitation-mixed is mixed with the catalyst and the like to produce an aid. In this case as well, a soft polyurethane foam 11 having a high air permeability can be obtained.

FIG. 1(b) is a schematic diagram of a cross section of the soft polyurethane foam 11 molded by using the raw material composition containing the aid with which the gas has been mixed. Cells 16 appear in the cross section obtained by cutting the soft polyurethane foam 11. The number of the cells in the soft polyurethane foam 11 is 20 to 40/25 mm. The number of the cells is obtained by, according to the method described in Annex 1 of JIS K 6400-1: 2004, counting the number of cells within a 10 mm straight line and multiplying this number by 2.5. The number of the cells is the average of measurement values at three randomly selected places on the cross section.

When the number of the cells is smaller than 20/25 mm, the areas of walls to which the skin 12 (see FIG. 1(a)) and the base fabric 13 are fused are small, and thus the adhesion strengths of the skin 12 and the base fabric 13 tend to decrease. Meanwhile, when the number of the cells exceeds 40/25 mm, the air permeability of the soft polyurethane foam 11 tends to decrease. Thus, the number of the cells needs to be within the range of 20 to 40/25 mm in order to ensure the adhesion strengths of the skin 12 and the base fabric 13 and high air permeability.

The soft polyurethane foam 11 has a structure in which the cells 16 are three-dimensionally connected to each other. Thus, air bubbles 17 lead to the cells 16. If the air bubbles 17 are closed by a thin membrane, the air permeability of the soft polyurethane foam 11 is adversely influenced. In view of this, the air bubbles 17 leading to the cells 16 have an opening proportion of 90% or higher and preferably 95% or higher in order to improve the air permeability. The opening proportion is the proportion (%) of the number of open air bubbles 17 to the number of all of the air bubbles 17 leading to the cells 16 intersecting with the 25 mm straight line used for obtaining the number of the cells.

In the soft polyurethane foam 11, the opening proportion of the air bubbles 17 can be made 90% or higher without performing membrane removal treatment for removing a membrane closing the air bubbles 17 (e.g., treatment in which combustible gas is exploded around the soft polyurethane foam 11) on the soft polyurethane foam 11. Since such membrane removal treatment does not need to be performed, the soft polyurethane foam 11 has no sign of membrane removal treatment such as a sign of melting of surfaces of ribs 18 between the air bubbles 17, and the surfaces of the ribs 18 have poor smoothness and are rough.

The ribs 18 have a thickness T which is the average of the thicknesses of five ribs 18 measured by using a digital microscope (e.g., VHX-D510 manufactured by KEYENCE CORPORATION), the five ribs 18 having been randomly selected from among the ribs 18 intersecting with the 25 mm straight line used for obtaining the number of the cells. Thicknesses at the centers between intersections of mutually intersecting ribs 18 among the ribs 18 are measured. The average is a value obtained by rounding the calculated value to the nearest one.

When soft polyurethane foams 11 having approximately equal densities are compared, larger thicknesses of the ribs 18 lead to a smaller number of the cells. The skin 12 and the base fabric 13 are fused to walls of the cells 16, and thus, when the number of the cells becomes small, the adhesion strengths of the skin 12 and the base fabric 13 become low. Meanwhile, when the number of the cells becomes large, the adhesion strengths of the skin 12 and the base fabric 13 tend to become high, but the ribs 18 become thin and the air permeability of the soft polyurethane foam 11 becomes low. The thickness T of the ribs 18 is suitably 80 μm or larger and 120 μm or smaller in order to ensure the air permeability of the soft polyurethane foam 11 and ensure the adhesion strengths of the skin 12 and the base fabric 13.

The fusion layers 14 and 15 of the multilayer body 10 (see FIG. 1(a)) are each made by melting the soft polyurethane foam 11. The skin 12 is fixed to the soft polyurethane foam 11 by fusing the soft polyurethane foam 11. The base fabric 13 is fixed to the soft polyurethane foam 11 by fusing the soft polyurethane foam 11. Since the skin 12 and the base fabric 13 are fixed by fusing the soft polyurethane foam 11 through so-called frame lamination, losses in the elasticity and the stretchability of the soft polyurethane foam 11 due to the fusion layers 14 and 15 can be decreased.

The fusion layer 14 formed by melting the soft polyurethane foam 11 is obtained by, for example, melting a portion near the front surface of the soft polyurethane foam 11 by flame, then superposing the skin 12, and solidifying the melted portion in a pressure-applied state. The fusion layer 15 formed by melting the soft polyurethane foam 11 is obtained by, for example, melting a portion near the back surface of the soft polyurethane foam 11 by flame, then superposing the base fabric 13, and solidifying the melted portion in a pressure-applied state.

When the air bubbles 17 leading to the cells 16 of the soft polyurethane foam 11 are closed by a thin membrane, melting of the soft polyurethane foam 11 in order to provide the fusion layers 14 and 15 causes the membrane to melt as well so that the air bubbles 17 are closed or downsized. Consequently, the air permeability of the multilayer body 10 decreases.

Meanwhile, in the present embodiment, the air bubbles 17 leading to the cells 16 of the soft polyurethane foam 11 have an opening proportion of 90% or higher, and thus no or few membranes are adhered to the air bubbles 17. Consequently, it is possible to suppress closing and downsizing of the air bubbles 17 at the time of melting the soft polyurethane foam 11. Therefore, high air permeability of the multilayer body 10 can be ensured.

The soft polyurethane foam 11 has an air permeability of 160 mL/cm²/s or more and 450 mL/cm²/s or less. The air permeability of the multilayer body 10 with respect to the air permeability of the skin 12 is 74% or higher. The air permeabilities of the skin 12, the multilayer body 10, and the soft polyurethane foam 11 are values measured according to the method B defined in JIS K 6400-7: 2012. Since the ratio of the air permeability (mL/cm²/s) of the multilayer body 10 in which the skin 12 has been fused to the soft polyurethane foam 11 to the air permeability (mL/cm²/s) of the skin 12 regarded as 1 is 74% or higher, it is possible to obtain a multilayer body 10 that sustains little loss due to the fusion layer 14 and that has a high air permeability.

### EXAMPLES

The present invention will be described in more detail with reference to Examples, but the present invention is not limited to the Examples. Table 1 indicates formulas of raw materials of soft polyurethane foams forming multilayer bodies in Examples 1 to 12 and Comparative Examples 1 and 2. The numerical values indicated in Table 1 are each a unit mass per 100 parts by weight of the polyol. The indexes are each a value obtained by multiplying, by 100, the number of moles of isocyanate group per 1 mole of active hydrogen group contained in the corresponding raw materials. The amounts of a gas are each a value equivalent to an amount in a standard state at 0° C. and at 1 atm.

TABLE 1

| | | | Examples | | | | | | |
|---|---|---|---|---|---|---|---|---|---|
| | | | 1 | 2 | 3 | 4 | 5 | 6 | 7 |
| polyol | | 1 | 100 | 100 | 100 | 100 | 100 | 100 | 100 |
| | | 2 | | | | | | | |
| | | 3 | | | | | | | |
| aid | catalyst | 1 | * 0.4 | * 0.4 | * 0.4 | * 0.4 | * 0.4 | * 0.4 | 0.4 |
| | | 2 | * 0.14 | * 0.14 | * 0.14 | * 0.14 | * 0.14 | * 0.14 | * 0.14 |
| | foam | 1 | * 0.8 | * 0.8 | * 0.8 | * 0.8 | * 0.8 | * 0.8 | * 0.8 |
| | stabilizer | 2 | | | | | | | |
| | | 3 | | | | | | | |

| | flame | * 16 | * 16 | * 16 | 16 | 16 | 16 | * 16 |
|---|---|---|---|---|---|---|---|---|
| | retardant | | | | | | | |
| | flame | * 2 | * 2 | * 2 | 2 | 2 | 2 | 2 |
| | retardant | | | | | | | |
| | aid | | | | | | | |
| gas (×10⁻³m³) | | 90 | 90 | 90 | 180 | 140 | 110 | 70 |
| colorant | | 1.35 | 1.35 | 1.35 | 1.35 | 1.35 | 1.35 | 1.35 |
| foaming agent | | 3.5 | 3.5 | 3.5 | 3.5 | 3.5 | 3.5 | 3.5 |
| isocyanate | | | | | | | | |
| | index | 111.0 | 111.0 | 111.0 | 111.0 | 111.0 | 111.0 | 111.0 |

| density (kg/m³) | | 30 | 30 | 30 | 30 | 30 | 30 | 30 |
|---|---|---|---|---|---|---|---|---|
| 25% ILD (N/314 cm²) | | 110 | 110 | 110 | 110 | 110 | 110 | 110 |
| number of cell (/25 mm) | | 31 | 31 | 31 | 33 | 32 | 31 | 29 |
| thickness of rib(μm) | | 100 | 100 | 100 | 80 | 90 | 95 | 105 |
| opening proportion | | 100 | 100 | 100 | 100 | 100 | 100 | 100 |
| of air bubble (%) | | | | | | | | |
| air permeability | | 225 | 225 | 225 | 160 | 180 | 190 | 250 |
| (mL/cm²/s) | | | | | | | | |
| skin | 1 | ◯ | | | ◯ | ◯ | ◯ | ◯ |
| | 2 | | ◯ | | | | | |
| | 3 | | | ◯ | | | | |

| | | | | | | | |
|---|---|---|---|---|---|---|---|
| ratio of air | 80 | 95 | 94 | 74 | 76 | 77 | 81 |
| permeability (%) | | | | | | | |

| | | | | | | | | Comparative | |
|---|---|---|---|---|---|---|---|---|---|
| | | | Examples | | | | | Examples | |
| | | | 8 | 9 | 10 | 11 | 12 | 1 | 2 |
| polyol | | 1 | 100 | 100 | 100 | 100 | 100 | 100 | 100 |
| | | 2 | | | | | | | |
| | | 3 | | | | | | | |
| aid | catalyst | 1 | 0.4 | 0.4 | * 0.5 | * 0.5 | * 0.5 | 0.4 | 0.5 |
| | | 2 | * 0.14 | * 0.14 | * 0.16 | * 0.16 | * 0.16 | 0.14 | 0.16 |
| | foam | 1 | * 0.8 | * 0.8 | * 0.8 | * 0.8 | * 0.8 | 0.8 | 0.8 |
| | stabilizer | 2 | | | | | | | |
| | | 3 | | | | | | | |

| | | | | | | | |
|---|---|---|---|---|---|---|---|
| flame | * 16 | * 16 | 18 | 18 | 18 | 16 | 18 |
| retardant | | | | | | | |
| flame | 2 | 2 | * 2 | * 2 | * 2 | 2 | 2 |
| retardant | | | | | | | |
| aid | | | | | | | |

| | | | | | | | |
|---|---|---|---|---|---|---|---|
| gas (×10⁻³m³) | 50 | 20 | 70 | 50 | 20 | 0 | 0 |
| colorant | 1.35 | 1.35 | 1.35 | 1.35 | 1.35 | 1.35 | 1.35 |
| foaming agent | 3.5 | 3.5 | 4.5 | 4.5 | 4.5 | 3.5 | 4.5 |
| isocyanate | | | | | | | |

| | | | | | | | |
|---|---|---|---|---|---|---|---|
| index | 111.0 | 111.0 | 110.5 | 110.5 | 110.5 | 111.0 | 110.5 |

| density (kg/m³) | | 30 | 30 | 25 | 25 | 25 | 30 | 25 |
|---|---|---|---|---|---|---|---|---|
| 25% ILD (N/314 cm²) | | 110 | 110 | 105 | 105 | 105 | 120 | 115 |
| number of cell (/25 mm) | | 28 | 27 | 27 | 26 | 25 | 50 | 45 |
| thickness of rib(μm) | | 110 | 120 | 105 | 110 | 120 | 62 | 60 |
| opening proportion | | 100 | 100 | 100 | 100 | 100 | 40 | 40 |
| of air bubble (%) | | | | | | | | |
| air permeability | | 300 | 360 | 280 | 330 | 390 | 95 | 50 |
| (mL/cm²/s) | | | | | | | | |
| skin | 1 | ◯ | ◯ | ◯ | ◯ | ◯ | ◯ | ◯ |

2
3

| | | | | | | | |
|---|---|---|---|---|---|---|---|
| ratio of air | 86 | 89 | 84 | 88 | 90 | 49 | 51 |
| permeability (%) | | | | | | | |

The materials indicated in Table 1 are as follows. The air permeabilities of skins were measured according to the method B of JIS K 6400-7: 2012.
Polyol 1: polyether polyol having an average molecular weight of 3000 and a hydroxyl value of 56 mgKOH/g, with the number of functional groups being 3
Catalyst 1: amine-based catalyst, DABCO (registered trademark) 33 LV
Catalyst 2: metal catalyst, KOSMOS (registered trademark) T9
Foam stabilizer 1: VORASURF (registered trademark) SF2904
Flame retardant: phosphoric-acid-ester-based flame retardant
Flame retardant aid: Niax (registered trademark) FLE-200LF
Colorant: black pigment
Foaming agent: water
Gas: nitrogen gas
Isocyanate: toluene diisocyanate (TDI), with 75 to 85% of 2,4-toluene diisocyanate and 15 to 25% of 2,6-toluene diisocyanate
Skin 1: fabric (tricot) having an air permeability of 145 mL/cm²/s
Skin 2: a skin obtained by applying a vinyl chloride resin on the front surface of a fabric, the skin having sporadically existing holes penetrating the vinyl chloride resin, the skin having an air permeability of 58 mL/cm²/s
Skin 3: a skin obtained by applying a vinyl chloride resin on the front surface of a fabric, the skin having sporadically existing holes penetrating the vinyl chloride resin, the skin having an air permeability of 80 mL/cm²/s

### Example 1

The catalyst 1, the catalyst 2, the foam stabilizer, the flame retardant, and the flame retardant aid were weighed out, and agitation was performed while the gas metered by a thermal mass flowmeter was being mixed. Consequently, a mixture as an aid was obtained. The asterisks “*” marking the blending amounts for the aid in Table 1 indicate that the gas was mixed with the corresponding materials. The polyol, the colorant, the foaming agent, and the isocyanate were weighed out, the aid was added thereto, and agitation was performed. The resultant mixture was supplied onto a pressure-released conveyor to obtain a molded body as a soft polyurethane foam. The molded body was sliced into a thickness of 10 mm.

The back surface of the soft polyurethane foam was melted by flame, a base fabric was superposed, and the melted portion was solidified in a pressure-applied state, whereby the base fabric was fused. The base fabric was a fiber article (half-tricot) having a weight per unit area of 16 g/m², and had an air permeability of 750 mL/cm²/s. The front surface of the soft polyurethane foam was melted by flame, the skin 1 was superposed, and the melted portion was solidified in a pressure-applied state, whereby the skin 1 was fused. Consequently, a multilayer body in Example 1 was obtained.

### Examples 2 and 3

A multilayer body in Example 2 was obtained in the same manner as in Example 1, except that the skin 1 was substituted with the skin 2. A multilayer body in Example 3 was obtained in the same manner as in Example 1, except that the skin 1 was substituted with the skin 3.

### Examples 4 to 6

Multilayer bodies in Examples 4 to 6 were obtained in the same manner as in Example 1, except for the following. The catalyst 1, the catalyst 2, and the foam stabilizer were weighed out, and agitation was performed while the gas metered by the thermal mass flowmeter was being mixed. Consequently, a mixture was obtained. The polyol, the colorant, the foaming agent, the flame retardant, the flame retardant aid, and the isocyanate were weighed out, the mixture was added thereto, and agitation was performed. The resultant mixture was supplied onto a pressure-released conveyor to obtain a molded body as a soft polyurethane foam. Then, the molded body was sliced into a thickness of 10 mm.

### Examples 7 to 9

Multilayer bodies in Examples 7 to 9 were obtained in the same manner as in Example 1, except for the following. The catalyst 2, the foam stabilizer, and the flame retardant were weighed out, and agitation was performed while the gas metered by the thermal mass flowmeter was being mixed. Consequently, a mixture was obtained. The polyol, the colorant, the foaming agent, the catalyst 1, the flame retardant aid, and the isocyanate were weighed out, the mixture was added thereto, and agitation was performed. The resultant mixture was supplied onto a pressure-released conveyor to obtain a molded body as a soft polyurethane foam. Then, the molded body was sliced into a thickness of 10 mm.

### Examples 10 to 12

Multilayer bodies in Examples 10 to 12 were obtained in the same manner as in Example 1, except for the following. The catalyst 1, the catalyst 2, the foam stabilizer, and the flame retardant aid were weighed out, and agitation was performed while the gas metered by the thermal mass flowmeter was being mixed. Consequently, a mixture was obtained. The polyol, the colorant, the foaming agent, the flame retardant, and the isocyanate were weighed out, the mixture was added thereto, and agitation was performed. The resultant mixture was supplied onto a pressure-released conveyor to obtain a molded body as a soft polyurethane foam. Then, the molded body was sliced into a thickness of 10 mm.

### Comparative Examples 1 and 2

Multilayer bodies in Comparative Examples 1 and 2 were obtained in the same manner as in Example 1 or Example 10, except for the following. The materials were weighed out and were mixed without mixing the gas therewith. Then, the resultant mixture was supplied onto a pressure-released conveyor to obtain a molded body as a soft polyurethane foam. Then, the molded body was sliced into a thickness of 10 mm.

### (Density, Hardness, Number of Cells, Thickness of Ribs, Opening Proportion, and Air Permeability of Soft Polyurethane Foam)

The density, the 25% hardness, the number of cells, the thickness of ribs, the opening proportion of air bubbles leading to the cells, and the air permeability of each of the soft polyurethane foams in Examples 1 to 12 and Comparative Examples 1 and 2 were measured. The 25% hardness was measured according to the D method of JIS K 6400-2: 2012. The thickness of the ribs was obtained as the average of the thicknesses of five ribs measured by using a digital microscope, VHX-D510 manufactured by KEYENCE CORPORATION. The air permeability (mL/cm²/s) of the soft polyurethane foam was measured according to the method B of JIS K 6400-7: 2012. The results are indicated in Table 1.

### (Ratio of Air Permeability)

The air permeability (mL/cm²/s) of each of the multilayer bodies in Examples 1 to 12 and Comparative Examples 1 and 2 was measured according to the method B of JIS K 6400-7: 2012, and the ratio of the air permeability of the multilayer body to the air permeability of the skin was obtained with the air permeability (mL/cm²/s) of the skin being regarded as 1. The results are indicated in Table 1.

As indicated in Table 1, in each of the soft polyurethane foams in Examples 1 to 12, the number of the cells was within a range of 20 to 40/25 mm, and the opening proportion of the air bubbles was 100%. Meanwhile, in each of the soft polyurethane foams in Comparative Examples 1 and 2, the opening proportion of the air bubbles was 40%. It has become obvious that any soft polyurethane foam molded with the gas having been agitation-mixed with the aid allows improvement of the opening proportion of the air bubbles leading to the cells.

In each of the soft polyurethane foams in Examples 1 to 12, the ribs had a thickness within a range of 80 to 120 μm. Meanwhile, in the soft polyurethane foam in Comparative Example 1, the ribs had a thickness of 62 μm, and, in the soft polyurethane foam in Comparative Example 2, the ribs had a thickness of 60 μm. It has become obvious that any soft polyurethane foam molded with the gas having been agitation-mixed with the aid allows the thickness of the ribs influencing the 25% hardness and the air permeability to fall within the range of 80 to 120 μm.

Each of the soft polyurethane foams in Examples 1 to 12 had an air permeability within a range of 160 mL/cm²/s or more and 450 mL/cm²/s or less. Meanwhile, each of the soft polyurethane foams in Comparative Examples 1 and 2 had an air permeability of less than 100 mL/cm²/s. It has become obvious that any soft polyurethane foam molded with the gas having been agitation-mixed with the aid allows the air permeability to fall within the range of 160 mL/cm²/s or more and 450 mL/cm²/s or less. In particular, it has become obvious that each of the soft polyurethane foams in Examples 1 to 3 and 7 to 12 with the ribs having thicknesses of 100 μm or larger had an air permeability of more than 190 mL/cm²/s.

The ratio of the air permeability of each of the multilayer bodies in Examples 1 to 12 to the air permeability of the skin was 74 to 95%. Meanwhile, the ratio of the air permeability of the multilayer body in Comparative Example 1 to the air permeability of the skin was 49%, and the ratio of the air permeability of the multilayer body in Comparative Example 2 to the air permeability of the skin was 51%. It is inferred that, in each of the soft polyurethane foams molded with the gas having been agitation-mixed with the aid, there were no or few membranes closing the air bubbles leading to the cells, and thus, when a portion near the front surface of the soft polyurethane foam was melted in order to fuse the skin, closing or downsizing of the air bubbles due to melting of such membranes was suppressed. It is inferred that this suppression led to obtainment of a multilayer body having a high air permeability.

Production of each of the multilayer bodies through frame lamination unavoidably led to decrease in the air permeability due to melting of the soft polyurethane foam, but the Examples have made it obvious that such production leads to obtainment of a multilayer body in which loss in the air permeability can be decreased. It is obvious that disposition of such a multilayer body on a seating surface of a seat for a vehicle or the like leads to exhibition of a function of adjusting a temperature and a humidity, results in decrease in stuffiness perceived by an occupant, or otherwise allows improvement of comfort.

Although the present invention has been described above based on the embodiment, the present invention is not limited to the above embodiment at all. It can be easily understood that various modifications may be made without departing from the gist of the present invention.

Although the gas was agitation-mixed at the time of mixing some or all of the materials of the aid in each of the Examples, the present invention is not necessarily limited thereto. As a matter of course, the gas may be agitation-mixed with a mixture obtained by mixing the foaming agent in addition to some or all of the materials of the aid, and the resultant mixture may be mixed with the polyol and the isocyanate.

### DESCRIPTION OF REFERENCE NUMERALS

10 multilayer body
11 soft polyurethane foam
12 skin
13 base fabric
16 cell
17 air bubble
18 rib

1. A multilayer body comprising:
a soft polyurethane foam; and
a base fabric pasted on the soft polyurethane foam, wherein
the base fabric is fixed to the soft polyurethane foam by fusing the soft polyurethane foam, and
the soft polyurethane foam has an air permeability of 160 mL/cm²/s or more and 450 mL/cm²/s or less.

2. The multilayer body according to claim 1, further comprising a skin pasted on a surface of the soft polyurethane foam, the surface being opposite to a surface thereof to which the base fabric has been fixed, wherein
the skin is fixed to the soft polyurethane foam by fusing the soft polyurethane foam.

3. The multilayer body according to claim 2, wherein an air permeability of the multilayer body with respect to an air permeability of the skin is 74% or higher.

4. The multilayer body according to claim 1, wherein
the soft polyurethane foam includes:
cells, the number of which is 20 to 40/25 mm; and
air bubbles leading to the cells and having an opening proportion of 90% or higher.

5. The multilayer body according to claim 4, wherein the soft polyurethane foam further includes a rib between the air bubbles, the rib having a thickness of 80 μm or larger and 120 μm or smaller.
